(19) United States
(12) Patent Application Publication
(10) Pub. No.: US 2026/0343545 A1
(43) Pub. Date: Oct. 29, 2026

(54) METHODS AND APPARATUSES FOR UPLINK SUBBAND IN A FULL DUPLEX SYSTEM

(71) Applicant: LENOVO (BEIJING) LIMITED, Beijing (CN)

(72) Inventors: Yuantao Zhang, Beijing (CN); Ruixiang Ma, Beijing (CN); Hongmei Liu, Beijing (CN); Zhi Yan, Beijing (CN); Haiming Wang, Beijing (CN)

(21) Appl. No.: 19/102,501

(22) PCT Filed: Aug. 11, 2022
(86) PCT No.: PCT/CN2022/111759

§ 371 Date: Feb. 10, 2025

(51) Int. Cl. H04W 72/21; H04L 5/14

(52) U.S. Cl. CPC H04W 72/21; H04L 5/14

(57) ABSTRACT

Embodiments of the present disclosure relate to methods and apparatuses for uplink (UL) subband in a full duplex (FD) system. According to some embodiments of the present disclosure, a user equipment (UE) may include: a transceiver configured to receive configuration information which configures a first set of physical resources for a UL subband; and a processor coupled to the transceiver and configured to determine a second set of physical resources in the UL subband for a UL transmission based on the configuration information.

### TECHNICAL FIELD

Embodiments of the present disclosure generally relate to wireless communication technology, and more particularly to methods and apparatuses for uplink (UL) subband in a full duplex (FD) system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time. Details regarding UL subband in a full duplex system need to be studied.

### SUMMARY

Some embodiments of the present disclosure provide a user equipment (UE). The UE may include: a transceiver configured to receive configuration information which configures a first set of physical resources for a UL subband; and a processor coupled to the transceiver and configured to determine a second set of physical resources in the UL subband for a UL transmission based on the configuration information.

In some embodiments of the present disclosure, the first set of physical resources is configured in a downlink (DL) bandwidth part (BWP).

In some embodiments of the present disclosure, the processor is further configured to scale the first set of physical resources based on a subcarrier spacing (SCS) of the DL BWP and an SCS of a UL BWP.

In some embodiments of the present disclosure, the first set of physical resources is configured in a network carrier and an SCS for the UL subband is configured or pre-configured for the UE or predefined.

In some embodiments of the present disclosure, the processor is further configured to scale the first set of physical resources based on the SCS for the UL subband and an SCS of a UL BWP.

In some embodiments of the present disclosure, the transceiver is further configured to receive downlink control information (DCI) including an indication indicating a third set of resources in the UL BWP for the UL transmission, and wherein determining the second set of physical resources in the UL subband for UL transmission includes: determining the second set of physical resources in the UL subband based on the third set of resources.

In some embodiments of the present disclosure, the third set of resources and the second set of physical resources have the same absolute positions in a frequency domain or have different absolute positions in the frequency domain.

In some embodiments of the present disclosure, determining the second set of physical resources in the UL subband based on the third set of resources further comprises determining the second set of physical resources in the UL subband based on the third set of resources and a mapping relationship between a set of resources in the UL BWP and a set of resources in the UL subband.

In some embodiments of the present disclosure, the mapping relationship is determined based on an offset, and wherein the offset is configured or pre-configured for the UE or predefined.

In some embodiments of the present disclosure, the transceiver is further configured to receive DCI indicating the second set of physical resources in the UL subband for the UL transmission.

In some embodiments of the present disclosure, a padding bit(s) is added to one of a first frequency domain resource allocation field and a second frequency domain resource allocation field which has the smaller size, wherein the first frequency domain resource allocation field is included in the DCI and the second frequency domain resource allocation field is included in another DCI for scheduling a UL transmission in the UL BWP.

In some embodiments of the present disclosure, the first set of physical resources is configured in a UL BWP.

In some embodiments of the present disclosure, the processor is further configured to: scale the first set of physical resources based on an SCS of the UL BWP and an SCS of a DL BWP; and map the scaled first set of physical resources to a third set of physical resources in the DL BWP.

In some embodiments of the present disclosure, the scaled first set of physical resources and the third set of physical resources have the same absolute positions in a frequency domain.

In some embodiments of the present disclosure, the transceiver is further configured to receive DCI indicating a fourth set of physical resources in the UL BWP for the UL transmission, and wherein determining the second set of physical resources in the UL subband for UL transmission includes: mapping the fourth set of physical resources to the second set of physical resources in the UL subband, wherein the fourth set of physical resources and the second set of physical resources have the same absolute positions in a frequency domain.

In some embodiments of the present disclosure, the transceiver is further configured to receive DCI indicating the second set of physical resources in the UL subband for the UL transmission.

In some embodiments of the present disclosure, a padding bit(s) is added to a first frequency domain resource allocation field in the DCI such that a size of the first frequency domain resource allocation field is the same as a size of a second frequency domain resource allocation field in another DCI for scheduling a UL transmission in the UL BWP.

In some embodiments of the present disclosure, a padding bit(s) is added to one of first DCI scheduling the UL transmission in the UL subband or second DCI scheduling the UL transmission in a UL BWP which has the smaller size.

Some embodiments of the present disclosure provide a base station (BS). The UE may include: a transceiver configured to transmit configuration information which configures a first set of physical resources for a UL subband; and a processor coupled to the transceiver and configured to determine a second set of physical resources in the UL subband for a UL transmission based on the configuration information.

In some embodiments of the present disclosure, the first set of physical resources is configured in a DL BWP.

In some embodiments of the present disclosure, the processor is further configured to scale the first set of physical resources based on an SCS of the DL BWP and an SCS of a UL BWP.

In some embodiments of the present disclosure, the first set of physical resources is configured in a network carrier and an SCS for the UL subband is configured or pre-configured for the UE or predefined.

In some embodiments of the present disclosure, the processor is further configured to scale the first set of physical resources based on the SCS for the UL subband and an SCS of a UL BWP.

In some embodiments of the present disclosure, the transceiver is further configured to transmit DCI including an indication indicating a third set of resources in the UL BWP for the UL transmission, and wherein determining the second set of physical resources in the UL subband for UL transmission includes: determining the second set of physical resources in the UL subband based on the third set of resources.

In some embodiments of the present disclosure, the third set of resources and the second set of physical resources have the same absolute positions in a frequency domain or have different absolute positions in the frequency domain.

In some embodiments of the present disclosure, determining the second set of physical resources in the UL subband based on the third set of resources further comprises determining the second set of physical resources in the UL subband based on the third set of resources and a mapping relationship between a set of resources in the UL BWP and a set of resources in the UL subband.

In some embodiments of the present disclosure, the mapping relationship is determined based on an offset, and wherein the offset is configured or pre-configured for the UE or predefined.

In some embodiments of the present disclosure, the transceiver is further configured to transmit DCI indicating the second set of physical resources in the UL subband for the UL transmission.

In some embodiments of the present disclosure, the processor is further configured to add a padding bit(s) to one of a first frequency domain resource allocation field and a second frequency domain resource allocation field which has the smaller size, wherein the first frequency domain resource allocation field is included in the DCI and the second frequency domain resource allocation field is included in another DCI for scheduling a UL transmission in the UL BWP.

In some embodiments of the present disclosure, the first set of physical resources is configured in a UL BWP.

In some embodiments of the present disclosure, the processor is further configured to: scale the first set of physical resources based on an SCS of the UL BWP and an SCS of a DL BWP; and map the scaled first set of physical resources to a third set of physical resources in the DL BWP.

In some embodiments of the present disclosure, the scaled first set of physical resources and the third set of physical resources have the same absolute positions in a frequency domain.

In some embodiments of the present disclosure, the transceiver is further configured to transmit DCI indicating a fourth set of physical resources in the UL BWP for the UL transmission, and wherein determining the second set of physical resources in the UL subband for UL transmission includes: mapping the fourth set of physical resources to the second set of physical resources in the UL subband, wherein the fourth set of physical resources and the second set of physical resources have the same absolute positions in a frequency domain.

In some embodiments of the present disclosure, the transceiver is further configured to transmit DCI indicating the second set of physical resources in the UL subband for the UL transmission.

In some embodiments of the present disclosure, the processor is further configured to add a padding bit(s) to a first frequency domain resource allocation field in the DCI such that a size of the first frequency domain resource allocation field is the same as a size of a second frequency domain resource allocation field in another DCI for scheduling a UL transmission in the UL BWP.

In some embodiments of the present disclosure, the processor is further configured to add a padding bit(s) to one of first DCI scheduling the UL transmission in the UL subband or second DCI scheduling the UL transmission in a UL BWP which has the smaller size.

Some embodiments of the present disclosure provide a method performed by a UE. The method may include: receiving configuration information which configures a first set of physical resources for a UL subband; and determining a second set of physical resources in the UL subband for a UL transmission based on the configuration information.

Some embodiments of the present disclosure provide a method performed by a BS. The method may include: transmitting configuration information which configures a first set of physical resources for a UL subband; and determining a second set of physical resources in the UL subband for a UL transmission based on the configuration information.

Some embodiments of the present disclosure provide an apparatus.

According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system according to some embodiments of the present disclosure;

FIG. 2 illustrates exemplary duplex modes according to some embodiments of the present disclosure;

FIG. 3 illustrates exemplary radio resources in a time division duplex (TDD) system according to some embodiments of the present disclosure;

FIG. 4 illustrates exemplary resource allocation type 0 and resource allocation type 1 according to some embodiments of the present disclosure;

FIG. 5 is a flow chart illustrating an exemplary method for a UL subband in a full duplex system according to some embodiments of the present disclosure;

FIGS. 6(a) and 6(b) illustrate exemplary scaling methods according to some embodiments of the present disclosure;

FIGS. 7(a)-8(b) illustrate exemplary resource mapping methods according to some embodiments of the present disclosure;

FIG. 9 is a flow chart illustrating an exemplary method for a UL subband in a full duplex system according to some other embodiments of the present disclosure; and

FIG. 10 illustrates a simplified block diagram of an exemplary apparatus for a UL subband in a full duplex system according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

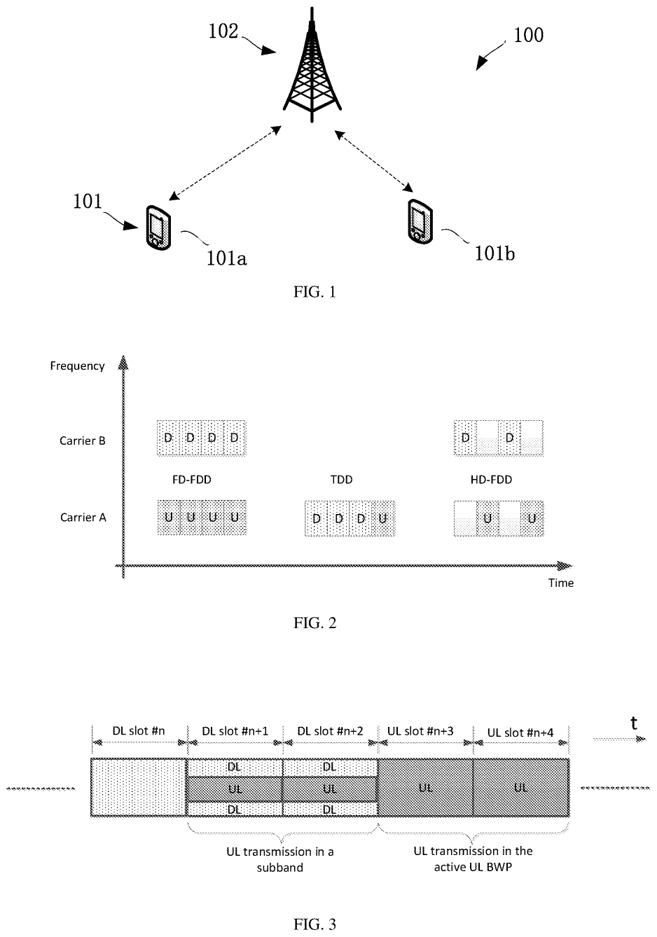

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a BS (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via UL communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via DL communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time.

FIG. 2 illustrates exemplary duplex modes according to some embodiments of the present disclosure.

Referring to FIG. 2, duplex modes may include, for example, a full duplex frequency division duplex (FD-FDD) mode, a TDD mode, and a half duplex frequency division duplex (HD-FDD) mode.

In some examples, in a full duplex transceiver, different carrier frequencies (e.g., carrier A and carrier B) may be employed for transmissions in each link direction, for example, carrier A may be used for the uplink transmissions while carrier B may be used for the downlink transmissions. Such kind of full duplex may be referred to as the FD-FDD mode.

In a half duplex (HD) transceiver, transmissions in each link direction may be separated by time domain resources. In some cases, the same carrier frequency is used for transmissions in each link direction, for example, carrier A is used for both the uplink and downlink transmissions, whereby such kind of half duplex may be referred to as the TDD mode. In some other cases, different carrier frequencies may be used for transmissions in each link direction, for example, carrier A may be used for the uplink transmissions while carrier B may be used for the downlink transmissions, whereby such kind of half duplex may be referred to as the HD-FDD mode.

Embodiments of the present disclosure provide improvements on the duplex modes, for example, as illustrated in FIG. 2. For example, advanced full duplex modes which enable simultaneous transmission and reception by the same device on the same carrier are provided. The advanced full duplex modes are advantageous. For example, the advanced full duplex modes may improve link throughput. In addition, transmission latency in the advanced full duplex modes may also be reduced due to simultaneous bidirectional transmission.

However, simultaneous DL transmission and UL transmission in the same carrier may incur self-interference. For example, on the BS side, the DL transmission may contaminate UL reception, while on the UE side, the UL transmission may contaminate DL reception.

It is more feasible to realize a full duplex on the BS side than on the UE side due to the following reasons. First, more space is available on the BS side such that transmitter (Tx) and receiver (Rx) antenna branches can be separated for self-interference cancellation. In addition, a more complex and advanced transceiver can be used on the BS side, which may be fundamental for self-interference cancellation.

Given the above, one scenario for implementing a full duplex mode is to deploy a full duplex mode on the BS side only, while still deploying a half duplex mode on the UE side. In such scenario, in a time unit (e.g., in terms of slot, symbol, sub-slot, etc.) with a full duplex mode, the BS may perform UL receptions from some UEs while performing DL transmissions to some other UEs. Non-overlapped frequency resources in the time unit may be allocated for UL receptions (from some UEs) and DL transmissions (to some other UEs) to mitigate self-interference. Such kind of full duplex mode may be referred to as a subband full duplex (SBFD).

The SBFD may be used in a TDD system to improve UL performance in the TDD system. For example, with the SBFD on the BS side, a UL subband(s) may be configured in some DL slots such that the UL transmission can be extended to be within such UL subband(s) in the DL slots while the DL transmission may be scheduled in the resources out of the UL subband(s). Here a subband corresponds to a set of frequency domain resources, e.g., a set of resource elements (REs) or resource blocks (RBs), and may be applicable to a time duration that is configured by a BS. Although the terminology “subband” is used for describing the embodiments of the present disclosure, other terminologies that correspond to a similar resource allocation to the subband, such as bandwidth part, are also applicable to the embodiments of the present disclosure.

FIG. 3 illustrates exemplary radio resources in a time division duplex (TDD) system according to some embodiments of the present disclosure.

In some examples, in a TDD system, DL transmissions and UL transmissions may be separated by time domain resources (e.g., slots). For example, the DL transmissions may be performed in DL slots #n-#n+2 as shown in FIG. 3 while the UL transmissions may be performed in the UL slots #n+3-#n+4 as shown in FIG. 3.

The SBFD on the BS side may be introduced to the TDD system. For example, for the UEs supporting the SBFD on the BS side, in addition to the UL transmission which may be scheduled in the active UL bandwidth parts (BWPs) in the UL slots, the UL transmission may also be scheduled in a subband in the DL slots in the TDD system. As shown in FIG. 3, UL transmissions may occur in a subband in DL slots #n+1 and #n+2. In other words, slot #n+1 and #n+2 are configured with a UL subband(s).

In some embodiments of the present disclosure, a UE may receive configurations for one or more DL BWPs or one or more UL BWPs. A configuration for a DL BWP or a UL BWP (e.g., BWP-Downlink for a DL BWP or BWP-Uplink for a UL BWP as specified in 3GPP standard documents) may at least include the following parameters for the DL BWP or the UL BWP:
a parameter (e.g., subcarrierSpacing as specified in 3GPP standard documents) which configures SCS for the DL BWP or the UL BWP;
a parameter (e.g., cyclicPrefix as specified in 3GPP standard documents) which configures a cyclic prefix for the DL BWP or the UL BWP;
a resource indication value (RIV) (e.g., locationAndBandwidth as specified in 3GPP standard documents) which configures an offset (e.g., denoted as RBₛₜₐᵣₜ) and a length (e.g., a number of contiguous RBs, which is denoted as L_{RB}) of the the DL BWP or the UL BWP. For example, L_{RB} may be equal to

$${N}_{BWP}^{size} ,$$

wherein

$${N}_{BWP}^{size}$$

is the network carrier size

$$( e . g . , {N}_{BWP}^{size} = 275 RBs ) .$$

In some embodiments, a start RB (e.g., denoted as

$${N}_{B W P}^{s t a r t} )$$

of the DL BWP or the UL BWP may be determined based on the equation:

$${N}_{B W P}^{s t a r t} = {O}_{c a r r i e r} + R {B}_{s t a r t} ,$$

wherein O_{carrier} may be provided by another parameter (e.g., offsetToCarrier as specified in 3GPP standard documents) for the SCS;
a parameter (e.g., BWP-Id as specified in 3GPP standard documents) which indicates an index of the DL BWP or the UL BWP in a set of DL BWPs or UL BWPs or indicates an ID of the DL BWP or the UL BWP; and
a set of parameters regarding the channels or signal transmissions in the DL BWP or in the UL BWP.

In an embodiment of the present disclosure, the SCS for the DL BWP and the SCS for the UL BWP may be configured separately. The SCS of the DL BWP and the SCS of the UL BWP may be configured with the same value or different values.

In an embodiment of the present disclosure, the size for the DL BWP (e.g., the number of RBs included in the DL BWP) and the size for the UL BWP (e.g., the number of RBs included in the UL BWP) may be configured separately. The size of the DL BWP and the size of the UL BWP may be configured with the same value or different values.

In a TDD system, the active DL BWP and the active UL BWP may have the same BWP ID, and their center frequencies may be aligned.

In some embodiments of the present disclosure, two resource allocation types may be used for frequency domain resource allocation for DL transmission (e.g., PDSCH transmission) or UL transmission (e.g., PUSCH transmission). For example, the two resource allocation types may be referred to as resource allocation type 0 (also referred to as type 0) and resource allocation type 1 (also referred to as type 1).

Resource allocation type 0 is a bitmap-based resource allocation scheme, wherein each bit may indicate whether a corresponding resource block (RB) group (RBG) is used for a PDSCH transmission or a PUSCH transmission, wherein each RBG may include more than one RB.

Resource allocation type 1 uses a start position and a length of the RB allocation to indicate a resource allocation for a PDSCH transmission or a PUSCH transmission. For example, the resource allocation in resource allocation type 1 may be indicated by an RIV, which indicates a starting resource block (e.g., denoted as RBₛₜₐᵣₜ) and a length (e.g., a number of continuous resource blocks, which is denoted as L_{RBs}) of the resource allocation. The RIV may be defined by the following equations.

$$if ( {L}_{RBs} - 1 ) \leq ⌊ \frac{{N}_{B W P}^{size}}{2} ⌋$$

$$RIV = {N}_{B W P}^{s i z e} ( {L}_{RBs} - 1 ) + {RB}_{start} ;$$

$$else ,$$

$$RIV = {N}_{B W P}^{s i z e} ( {N}_{B W P}^{s i z e} - {L}_{R B s} + 1 ) + ( {N}_{B W P}^{s i z e} - 1 - R {B}_{start} ) ,$$

wherein

$${N}_{B W P}^{s i z e}$$

is the size of the active BWP (e.g., the number of RBs included in the active (BWP), L_{RBs}≥1 and is no greater than

$${N}_{B W P}^{s i z e} - R {B}_{start} .$$

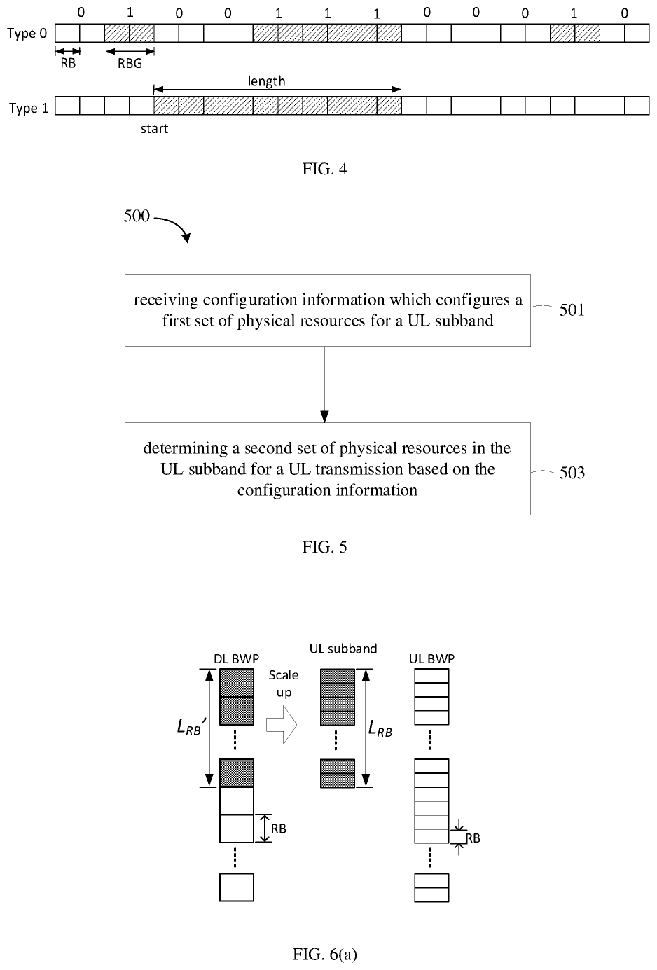

FIG. 4 illustrates an exemplary resource allocation type 0 and an exemplary resource allocation type 1 according to some embodiments of the present disclosure. In the example of FIG. 4, it is assumed that a BWP includes 24 RBs.

Referring to resource allocation type 0 (e.g., Type 0) in FIG. 4, each RBG may include two RBs. A UE may receive a bitmap “010011100010” indicating a resource allocation in the BWP for a PDSCH transmission or a PUSCH transmission, wherein “0” indicates that the corresponding RBG is not used for the PDSCH transmission or the PUSCH transmission, whereas “1” indicates that the corresponding RBG is used for the PDSCH transmission or the PUSCH transmission.

Referring to resource allocation type 1 (e.g., Type 1) in FIG. 4, a UE may receive information indicating a resource allocation in the BWP for a PDSCH transmission or a PUSCH transmission. The information may be an RIV indicating a start position (e.g., the fifth RB in the BWP) of the resource allocation and a length (e.g., 10 RBs) of the resource allocation, for example,

$$RIV = {N}_{B W P}^{s i z e} ( {L}_{R B s} - 1 ) + {RB}_{start} = 24 * ( 10 - 1 ) + 4 = 230 .$$

In some embodiments of the present disclosure, to reduce the PDCCH blind decoding efforts, a UE may support up to 4 DCI sizes. If a size of the DCI does not belong to the 4 DCI sizes, a padding bit(s) may be added to the DCI or a truncation to the DCI may be performed. Such operation may be referred to as DCI size alignment.

Embodiments of the present disclosure provide solutions for UL subband allocation in the frequency domain (e.g., allocating frequency resources for a UL subband) and resource allocation for UL transmission in the UL subband. For example, the following three solutions may be used for UL subband allocation in the frequency domain.
Solution 1: a set of physical resources (e.g., RBs) in a DL BWP may be allocated (or configured) for a UL subband;
Solution 2: a set of physical resources (e.g., RBs) in a UL BWP may be allocated (or configured) for a UL subband; and
Solution 3: a set of physical resources (e.g., RBs) in a network carrier may be allocated (or configured) for a UL subband.

In solution 1, the frequency resources for the UL subband may be configured by using resource allocation type 1 as stated above. For example, the UE may receive an RIV indicating a starting RB and a length of RBs in the DL BWP for the UL subband. Accordingly, the SCS of the allocated RBs for the UL subband is the same as the SCS of the DL BWP, and may be different from the SCS configured for the UL BWP. As a result, from a UE's point of view, the SCS of a UL transmission (e.g., PUSCH transmission) in the UL subband and a UL transmission (e.g., PUSCH transmission) in the UL BWP may be different, and thus the UE may need to perform SCS switching between the UL transmission in the UL subband and the UL transmission in the UL BWP. This may increase the complexity of the operations performed on the UE side (e.g., the UE may perform more complex fast Fourier transform (FFT)), and also cause the PUSCH scheduling to be more complex on the BS side.

In solution 2, the frequency resources for the UL subband may be configured by using resource allocation type 1 as stated above. For example, the UE may receive an RIV indicating a starting RB and a length of RBs in the UL BWP for the UL subband. Accordingly, the SCS of the allocated RBs for the UL subband is the same as the SCS of the UL BWP, and may be different from the SCS configured for the DL BWP. In solution 2, from a UE's point of view, the resources of the UL subband may be mapped to the resources in the DL BWP. Otherwise, when a DL transmission (e.g., PDSCH transmission) is scheduled in the DL BWP and includes the resources of the UL subband, the UE cannot perform a rate matching around the resources of the UL subband for the DL transmission.

In solution 3, the UL subband is configured in a network carrier. In other words, the frequency resources for the UL subband may be configured in a network carrier. The SCS of the UL subband may be configured, preconfigured, or predefined to be a value which is the same as the SCS of the UL BWP or the DL BWP or different from the SCS of the UL BWP or the DL BWP (for example, the SCS of the UL subband may be configured, preconfigured, or predefined to be a value which is the same as the DL BWP). When the SCS of the UL subband is different from the SCS of the UL BWP, solution 3 may involve a similar problem as in solution 1. When the SCS of the UL subband is different from the SCS of the DL BWP, solution 3 may involve a similar problem as in solution 2.

Embodiments of the present disclosure further provide enhanced solutions for resource allocation within the UL subband for UL transmission in a full duplex system. The enhanced solutions in the embodiments of the present disclosure can at least solve the above technical problems. More details on embodiments of the present disclosure will be described in the following text in combination with the appended drawings.

FIG. 5 is a flow chart illustrating an exemplary method for a UL subband in a full duplex system according to some embodiments of the present disclosure. The method in FIG. 5 may be implemented by a UE (e.g., UE 101 as shown in FIG. 1).

In the exemplary method shown in FIG. 5, in step 501, a UE may receive, from a BS (e.g., BS 102 as shown in FIG. 1), configuration information which configures a first set of physical resources (e.g., RBs or resource elements (REs)) for a UL subband. In step 503, the UE may determine a second set of physical resources in the UL subband for a UL transmission (e.g., PUSCH transmission) based on the configuration information.

According to some embodiments of the present disclosure, the first set of physical resources may be configured in a DL BWP (e.g., the resource allocation for the UL subband may use solution 1 as stated above). As stated in solution 1, when the SCS of the DL BWP is different from the SCS of a UL BWP, the UE needs to perform SCS switching when transmitting a UL transmission in the UL subband and in the UL BWP.

In order to solve the above technical problem, the UE may scale the first set of physical resources based on the SCS of the DL BWP and the SCS of a UL BWP. The scaling may be performed based on the requirement that the SCS of the UL subband is the same as the SCS of the UL BWP, such that the UE does not need to perform SCS switching when transmitting a UL transmission in the UL subband and in the UL BWP. In the case that the SCS of the DL BWP and the SCS of a UL BWP are the same, the scaling operation may be omitted.

In some cases, the SCS of the DL BWP may be larger than the SCS of the UL BWP, then the size of the first set of physical resources (e.g., the number of physical resources (e.g., RBs or REs) included in the first set of physical resources) may be scaled up.

In some cases, the SCS of the DL BWP may be smaller than the SCS of the UL BWP, then the size of the first set of physical resources (e.g., the number of physical resources (e.g., RBs or REs) included in the first set of physical resources) may be scaled down.

For example, the UE may perform the scaling based on the following equation:

$${L}_{RB} = {L}_{RB}^{′} * \frac{{SCS}_{{DL}_{BWP}}}{{SCS}_{{UL}_{BWP}}} ,$$

wherein L_{RB} is the number of RBs included in the UL subband after scaling,

$${L}_{RB}^{′}$$

is the number of KBS included in the first set of physical resources allocated for the UL subband in the DL BWP, SCS_{DL}_{_{BWP}} is the SCS of the DL BWP, and SCS_{UL}_{_{BWP}} is the SCS of the UL BWP.

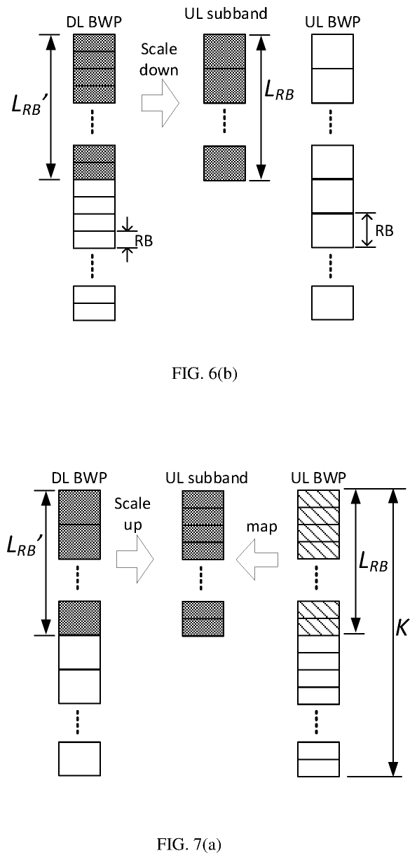

FIGS. 6(a) and 6(b) illustrate exemplary scaling methods according to some embodiments of the present disclosure. In FIGS. 6(a) and 6(b), it is assumed that the configuration information in step 501 configures

$${L}_{RB}^{′}$$

RBs in a DL BWP for a UL subband.

Referring to FIG. 6(a), it is assumed that the SCS of the DL BWP is twice the SCS of the UL BWP. The UE may scale

$${L}_{RB}^{′}$$

RBs to L_{RB} RBS based on the equation

$${L}_{R B} = {L}_{RB}^{′} * \frac{{SCS}_{{DL}_{BWP}}}{{SCS}_{{UL}_{BWP}}} .$$

### Since

$$\frac{{SCS}_{{DL}_{BWP}}}{{SCS}_{{UL}_{BWP}}} = 2 , {L}_{RB} = 2 * {L}_{RB}^{′} .$$

Referring to FIG. 6(b), it is assumed that the SCS of the DL BWP is half the SCS of the UL BWP. The UE may scale

$${L}_{RB}^{′}$$

RBs to L_{RB} RBs based on the equation

$${L}_{R B} = {L}_{RB}^{′} * \frac{{SCS}_{{DL}_{BWP}}}{{SCS}_{{UL}_{BWP}}} .$$

### Since

$$\frac{{SCS}_{{DL}_{BWP}}}{{SCS}_{{UL}_{BWP}}} = 1 / 2 , {L}_{R B} = {L}_{RB}^{′} / 2.$$

According to some embodiments of the present disclosure, the first set of physical resources may be configured in a network carrier (e.g., the resource allocation for the UL subband may use solution 3 as stated above). In such embodiments, SCS for the UL subband may be configured or pre-configured for the UE or predefined. As stated in solution 3, when the configured, pre-configured, or pre-defined SCS for the UL subband is different from the SCS of a UL BWP, the UE needs to perform SCS switching when transmitting a UL transmission in the UL subband and in the UL BWP.

In order to solve the above technical problem, the UE may scale the first set of physical resources based on the configured, pre-configured, or pre-defined SCS for the UL subband and the SCS of a UL BWP. The scaling may be performed based on the requirement that the SCS of the UL subband is the same as the SCS of the UL BWP, such that the UE does not need to perform SCS switching when transmitting a UL transmission in the UL subband and in the UL BWP. In the case that the SCS of the UL subband and the SCS of a UL BWP are the same, the scaling operation may be omitted.

In some cases, the configured, pre-configured, or pre-defined SCS for the UL subband may be larger than the SCS of the UL BWP, then the size of the first set of physical resources (e.g., the number of physical resources (e.g., RBs or REs) included in the first set of physical resources) may be scaled up.

In some cases, the configured, pre-configured, or pre-defined SCS for the UL subband may be smaller than the SCS of the UL BWP, then the size of the first set of physical resources (e.g., the number of physical resources (e.g., RBs or REs) included in the first set of physical resources) may be scaled down.

For example, the UE may perform the scaling based on the following equation:

$${L}_{RB} = {L}_{RB}^{′} * \frac{{SCS}_{{UL}_{subband}}}{{SCS}_{{UL}_{BWP}}} ,$$

wherein L_{RB} is the number of RBs included in the UL subband after scaling,

$${L}_{RB}^{′}$$

is the number of RBs included in the first set of physical resources allocated for the UL subband in the DL BWP, SCS_{UL}_{_{subband}} is the configured, pre-configured, or pre-defined SCS for the UL subband, and SCS_{UL}_{_{BWP}} is the SCS of the UL BWP.

Based on the methods in the above embodiments, a set of physical resources in the UL subband may be determined. The resource allocation for a UL transmission in the UL subband may be based on the set of physical resources. The following embodiments provide methods for resource allocation for a UL transmission in the UL subband.

In some embodiments of the present application, the UE may receive DCI including an indication indicating a third set of resources in the UL BWP for the UL transmission in the UL subband. In such embodiments, the size of a frequency domain resource allocation field in the DCI may be the same as the size of a frequency domain resource allocation field in another DCI for scheduling a UL transmission in the UL BWP. Accordingly, no operation is needed to align the sizes of the two DCIs from a resource indication point of view.

In such embodiments, the UE may determine the second set of physical resources in the UL subband based on the third set of resources. For example, the UE may perform a resource mapping such that based on the third set of resources in the UL BWP, the UE may determine the corresponding second set of physical resources in the UL subband for UL transmission.

In some cases, the third set of resources and the second set of physical resources may have the same absolute positions in a frequency domain. For example, the third set of resources in the UL BWP may map to the second set of physical resources in the UL subband such that they are in the same absolute positions in the frequency domain.

In some cases, the third set of resources and the second set of physical resources have different absolute positions in the frequency domain. For example, the third set of resources in the UL BWP may map to the second set of physical resources in the UL subband such that they are in different absolute positions in the frequency domain.

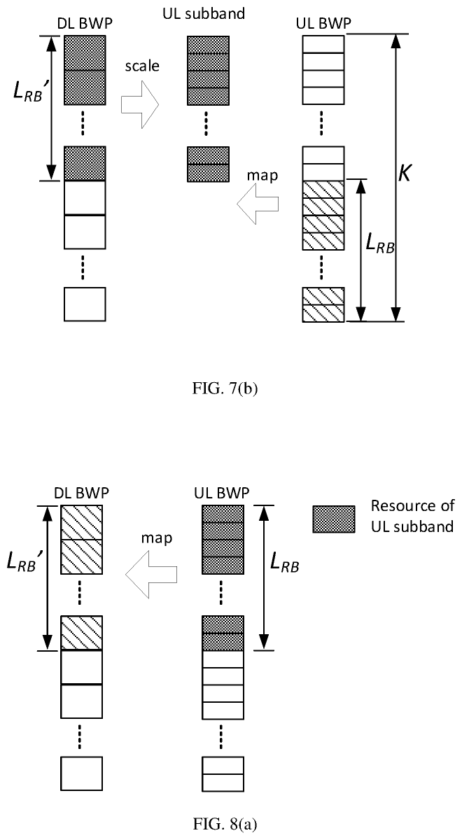

FIGS. 7(a) and 7(b) illustrate exemplary mapping methods according to some embodiments of the present disclosure.

Referring to FIG. 7(a), all the assumptions for FIG. 6(a) may apply here. It is further assumed that the UL BWP is configured with K RBs indexed from #0 to #K−1, and the DCI indicates L_{RB} RBs (e.g., RB #K-L_{RB} to RB #K−1) in the UL BWP for a UL transmission in the UL subband. As shown in FIG. 7(a), RB #K-L_{RB} to RB #K−1 in the UL BWP may be mapped to L_{RB} RBs of the UL subband and they have the same absolute positions in the frequency domain. For example, RB #K-L_{RB} to RB #K−1 in the UL BWP may be one-to-one mapped to the L_{RB} RBs of the UL subband, e.g., the UE may map RB #K-L_{RB} in the UL BWP to RB #0 in the UL subband, map RB #K-L_{RB}+1 in the UL BWP to RB #1 in the UL subband, . . . , map RB #K−1 in the UL BWP to RB #L_{RB}−1 in the UL subband.

Referring to FIG. 7(b), all the assumptions for FIG. 6(b) may apply here. It is further assumed that the UL BWP is configured with K RBs indexed from #0 to #K−1, and the DCI indicates L_{RB} RBs (e.g., RB #0 to RB #L_{RB}−1) for a UL transmission in the UL BWP. As shown in FIG. 7(b), RB #0 to RB #L_{RB}−1 in the UL BWP may be mapped to L_{RB} RBs of the UL subband and they have different absolute positions in the frequency domain. For example, RB #0 to RB #L_{RB}−1 in the UL BWP may be one-to-one mapped to the L_{RB} RBs of the UL subband, for example, the UE may map RB #0 in the UL BWP to RB #0 in the UL subband, map RB #1 in the UL BWP to RB #1 in the UL subband, . . . , map RB #K−1 in the UL BWP to RB #K−1 in the UL subband.

It should be noted that although the DCIs in the FIGS. 7(a) and 7(b) schedules the whole UL subband for a UL transmission, a DCI may schedule a part of the UL subband for a UL transmission, which may include consecutive or inconsecutive physical resources in the UL subband in some other embodiments of the present disclosure.

In an embodiment, determining the second set of physical resources in the UL subband based on the third set of resources may further include determining the second set of physical resources in the UL subband based on the third set of resources and a mapping relationship between a set of resources (e.g., RB or RBGs) in the UL BWP and a set of resources (e.g., RB or RBGs) in the UL subband.

In some embodiments, the mapping relationship may refer to that the set of resources (e.g., RB or RBGs) in the UL subband are one-to-one mapped to the set of resources (e.g., RB or RBGs) in the UL BWP or vice versa. For example, the mapping relationship may refer to that all the resources in the UL subband are one-to-one mapped to a set of resources in the UL BWP.

For example, in some cases, the mapping relationship may refer to that the set of resources (e.g., RB or RBGs) in the UL subband and the set of resources (e.g., RB or RBGs) in the UL BWP have the same positions in the frequency domain.

In some cases, the mapping relationship may be determined or defined by an offset (e.g., an RB offset or an RBG offset). In an embodiment, the offset may be configured or pre-configured for the UE or predefined (e.g., equal to 0). For example, assuming that the UL subband includes k RBs (e.g., denoted as RB #0-RB #k−1) and the offset is an RB offset “m,” then the mapping relationship may refer to that RB #0-RB #k−1 in the UL subband are mapped to RB #m-RB #m+k−1 in the UL BWP. In an embodiment, the offset may be determined based on the principle that the RBs or the RBGs of the UL subband have the same absolute frequency domain positions as the corresponding set of RBs or RBGs in the UL BWP. For example, it is assumed that the UL subband includes k RBs (e.g., denoted as RB #0-RB #k−1) and they are mapped to RB #m-RB #m+k−1 of the UL BWP, wherein RB #0-RB #k−1 of the UL subband have the same absolute frequency positions as RB #m-RB #m+k−1 of the UL BWP, and the RB offset is “m” in this example.

In some cases, resource allocation type 0 may be used for the resource allocation in the UL BWP. In such embodiments, when the UE receives the DCI indicating a set of RBGs in the UL BWP for a UL transmission, the UE may determine a set of RBGs in the UL subband for the UL transmission based on the mapping relationship. Alternatively, the UE may first determine a set of RBs in the UL BWP for the UL transmission from the set of RBGs in the UL BWP, and then determine a set of RBs in the UL subband for the UL transmission based on the set of RBs in the UL BWP and the mapping relationship.

For example, it is assumed that the mapping relationship may indicate an RBG offset “m” between resources in the UL subband and resources in the UL BWP, and the UE receives the DCI indicating RBGs [#n1, #n2, #n3] in the UL BWP which are used for the UL transmission in the UL subband. The UE may determine RBGs [#n1-m, #n2-m, #n3-m] in the UL subband are used for the UL transmission.

In some cases, resource allocation type 1 may be used for the resource allocation in the UL BWP. In such embodiments, when the UE receives the DCI including an RIV which indicates a set of RBs in the UL BWP for a UL transmission, the UE may determine a set of RBs in the UL subband for the UL transmission based on the set of RBs in the UL BWP and the mapping relationship.

For example, it is assumed that the mapping relationship may indicate that an RB offset “m” between resources in the UL subband and resources in the UL BWP, and the UE receives an RIV indicating RB #n-RB #n+L in the UL BWP which are used for the UL transmission in the UL subband. The UE may determine RB #n-m-RB #n+L-m in the UL subband are used for the UL transmission.

In some embodiments of the present application, the UE may receive DCI including an indication indicating the second set of physical resources in the UL subband for the UL transmission. In such embodiments, due to different sizes of the UL subband and the UL BWP, the size of a frequency domain resource allocation field in the DCI may be different from the size of a frequency domain resource allocation field in another DCI for scheduling a UL transmission in the UL BWP. To align the sizes of the two DCIs from a resource indication point of view, a padding bit(s) may be added to one of a first frequency domain resource allocation field and a second frequency domain resource allocation field which has the smaller size, wherein the first frequency domain resource allocation field is included in the DCI and the second frequency domain resource allocation field is included in the another DCI for scheduling a UL transmission in the UL BWP, such that the sizes of the first frequency domain resource allocation field and the second frequency domain resource allocation field are the same.

In the above embodiments, the UL subband may be within the UL BWP in the frequency domain or may be not within the UL BWP in the frequency domain.

According to some embodiments of the present disclosure, the first set of physical resources may be configured in a UL BWP (e.g., the resource allocation for the UL subband may use solution 2 as stated above). As stated in solution 2, when the SCS of the DL BWP is different from the SCS of a UL BWP, the first set of physical resources may be mapped to a set of physical resources in the DL BWP, such that the UE may determine the resources in the DL BWP for a PDSCH rate matching, e.g., the UE may avoid receiving a DL transmission (e.g., PDSCH transmission) in the RBs if they are allocated for the UL subband.

For example, the UE may scale the first set of physical resources based on the SCS of the UL BWP and the SCS of the DL BWP. The scaling may be performed based on the requirement that the SCS of the scaled first set of physical resources is the same as the SCS of the DL BWP.

In some cases, the SCS of the UL BWP may be larger than the SCS of the DL BWP, then the size of the first set of physical resources (e.g., the number of physical resources included in the first set of physical resources) may be scaled up.

In some cases, the SCS of the UL BWP may be smaller than the SCS of the DL BWP, then the size of the first set of physical resources (e.g., the number of physical resources included in the first set of physical resources) may be scaled down.

For example, the UE may perform the scaling based on the following equation:

$${L}_{RB}^{′} = {L}_{RB} * \frac{{SCS}_{{UL}_{BWP}}}{{SCS}_{{DL}_{BWP}}} ,$$

wherein

$${L}_{RB}^{′}$$

is the number of RBs included in the scaled first set of physical resources, L_{RB} is the number of RBs included in the first set of physical resources allocated for the UL subband in the UL BWP, SCS_{DL}_{_{BWP}} is the SCS of the DL BWP, and SCS_{UL}_{_{BWP}} is the SCS of the UL BWP.

Then, the UE may map the scaled first set of physical resources to a third set of physical resources in the DL BWP. In some embodiments of the present application, the scaled first set of physical resources and the third set of physical resources in the DL BWP have the same absolute positions in a frequency domain.

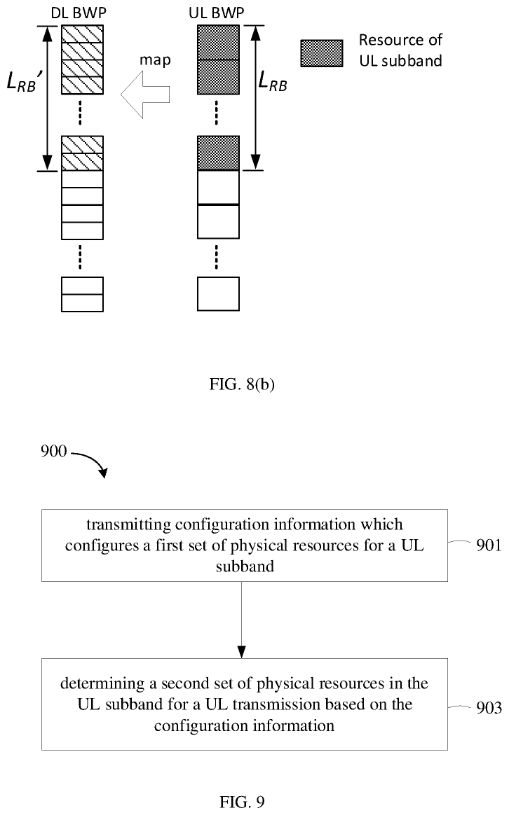

FIGS. 8(a) and 8(b) illustrate exemplary resource mapping methods according to some embodiments of the present disclosure. In FIGS. 8(a) and 8(b), it is assumed that the configuration information in step 501 may configure L_{RB} RBs in a UL BWP for a UL subband.

Referring to FIG. 8(a), it is assumed that the SCS of the DL BWP is twice the SCS of the UL BWP. The UE may scale L_{BR} RBs to

$${L}_{RB}^{′}$$

RBs in the DL BWP based on the equation

$${L}_{RB}^{′} = {L}_{RB} * \frac{{SCS}_{{UL}_{BWP}}}{{SCS}_{{DL}_{BWP}}} .$$

### Since

$$\frac{{SCS}_{{UL}_{BWP}}}{{SCS}_{{DL}_{BWP}}} = 1 / 2 ,$$

L′_{RB}=L_{RB}/2. The UE may map the L_{RB} RBs to L′_{RB} RBs in the DL BWP such that they have the same absolute positions in a frequency domain.

Referring to FIG. 8(b), it is assumed that the SCS of the DL BWP is half the SCS of the UL BWP. The UE may scale L_{BR} RBs to

$${L}_{RB}^{′}$$

RBs in the DL BWP based on the equation

$${L}_{RB}^{′} = {L}_{RB} * \frac{{SCS}_{{UL}_{BWP}}}{{SCS}_{{DL}_{BWP}}} .$$

### Since

$$\frac{{SCS}_{{UL}_{BWP}}}{{SCS}_{{DL}_{BWP}}} = 2 , {L}_{RB}^{′} = 2 {L}_{RB} .$$

The UE may map the L_{RB} RBs to L′_{RB} RBs in the DL BWP such that they have the same absolute positions in a frequency domain.

In such embodiments, the UL subband includes the first set of physical resources. The resource allocation for a UL transmission in the UL subband may be based on the first set of physical resources. The following embodiments may provide methods for resource allocation for a UL transmission in the UL subband.

In some embodiments of the present application, the UE may receive DCI including an indication indicating a fourth set of physical resources in the UL BWP for the UL transmission. In such embodiments, the size of a frequency domain resource allocation field in the DCI may be the same as the size of a frequency domain resource allocation field in another DCI for scheduling a UL transmission in the UL BWP. Accordingly, no operation is needed to align the sizes of the two DCIs from a resource indication point of view.

In such embodiments, the UE may determine the second set of physical resources in the UL subband based on the fourth set of physical resources. In an embodiment, determining the second set of physical resources in the UL subband for UL transmission may include mapping the fourth set of physical resources to the second set of physical resources in the UL subband, wherein the fourth set of physical resources and the second set of physical resources have the same absolute positions in a frequency domain.

For example, resource allocation type 0 may be used for the resource allocation in the UL BWP. In such example, when the UE receives the DCI indicating a set of RBGs in the UL BWP for a UL transmission, the UE may determine a set of RBGs in the UL subband for the UL transmission, wherein the set of RBGs in the UL subband may have the same absolute positions in the frequency domain with the set of RBGs in the UL BWP.

In another example, resource allocation type 1 may be used for the resource allocation in the UL BWP. In such example, when the UE receives the DCI including an RIV which indicates a set of RBs in the UL BWP for a UL transmission, the UE may determine a set of RBs in the UL subband for the UL transmission, wherein the set of RBs in the UL subband may have the same absolute positions in the frequency domain with the set of RBs in the UL BWP.

In some embodiments of the present application, the UE may receive DCI including an indication indicating a set of physical resources in the UL subband for the UL transmission. In such embodiments, the second set of physical resources in the UL subband for a UL transmission in step 503 may be the set of physical resources indicated by the DCI.

In such embodiments, since the size of the UL subband may be smaller than the UL BWP, the size of a frequency domain resource allocation field in the DCI may be smaller than the size of a frequency domain resource allocation field in another DCI for scheduling a UL transmission in the UL BWP. To align the sizes of the two DCIs from a resource indication point of view, a padding bit(s) may be added to a frequency domain resource allocation field in the DCI such that a size of the frequency domain resource allocation field is the same as a size of a frequency domain resource allocation field in another DCI for scheduling a UL transmission in the UL BWP.

According to some embodiments of the present application, the size of the DCI for scheduling a UL transmission in a UL subband should be the same as the size of the DCI for scheduling a UL transmission in a UL BWP. If the two DCIs have different sizes, a padding bit(s) may be added to one of the DCI scheduling the UL transmission in the UL subband and the DCI scheduling the UL transmission in the UL BWP which has the smaller size, such that the sizes of the two DCIs may be aligned (e.g., equal to each other).

FIG. 9 is a flow chart illustrating an exemplary method for a UL subband in a full duplex system according to some other embodiments of the present disclosure. The method in FIG. 9 may be implemented by a BS (e.g., BS 102 as shown in FIG. 1).

In the exemplary method shown in FIG. 9, in step 901, a BS may transmit, to a UE (e.g., UE 101 as shown in FIG. 1), configuration information which configures a first set of physical resources (e.g., RBs or REs) for a UL subband. In step 903, the BS may determine a second set of physical resources in the UL subband for a UL transmission (e.g., PUSCH transmission) based on the configuration information.

According to some embodiments of the present disclosure, the first set of physical resources may be configured in a DL BWP (e.g., the resource allocation for the UL subband may use solution 1 as stated above). In such embodiments, all the operations performed by the UE in FIG. 5 may apply here.

For example, the BS may scale the first set of physical resources based on the SCS of the DL BWP and the SCS of a UL BWP. The scaling may be performed based on the requirement that the SCS of the UL subband is the same as the SCS of the UL BWP such that the BS does not need to perform SCS switching when receiving a UL transmission in the UL subband and in the UL BWP. In the case that the SCS of the DL BWP and the SCS of a UL BWP are the same, the scaling operation may be omitted.

For example, the BS may perform the scaling based on the following equation:

$${L}_{RB} = {L}_{RB}^{′} * \frac{{SCS}_{{DL}_{BWP}}}{{SCS}_{{UL}_{BWP}}} ,$$

wherein L_{RB} is the number of RBs included in the UL subband after scaling,

$${L}_{RB}^{′}$$

is the number of RBs included in the first set of physical resources allocated for the UL subband in the DL BWP, SCS_{DL}_{_{BWP}} is the SCS of the DL BWP, and SCS_{UL}_{_{BWP}} is the SCS of the UL BWP. The examples for scaling may refer to FIGS. 6(a) and 6(b).

According to some embodiments of the present disclosure, the first set of physical resources may be configured in a network carrier (e.g., the resource allocation for the UL subband may use solution 3 as stated above). In such embodiments, SCS for the UL subband may be configured or pre-configured for the UE or predefined. In such embodiments, all the operations performed by the UE in FIG. 5 may apply here.

For example, the BS may scale the first set of physical resources based on the configured, pre-configured, or pre-defined SCS for the UL subband and the SCS of a UL BWP. The scaling may be performed based on the requirement that the SCS of the UL subband is the same as the SCS of the UL BWP, such that the BS does not need to perform SCS switching when receiving a UL transmission in the UL subband and in the UL BWP. In the case that the SCS of the UL subband and the SCS of a UL BWP are the same, the scaling operation may be omitted.

For example, the BS may perform the scaling based on the following equation:

$${L}_{RB} = {L}_{RB}^{′} * \frac{{SCS}_{{UL}_{subband}}}{{SCS}_{{UL}_{BWP}}} ,$$

wherein L_{RB} is the number of RBs included in the UL subband after scaling,

$${L}_{RB}^{′}$$

is the number of RBs included in the first set of physical resources allocated for the UL subband in the DL BWP, SCS_{UL}_{_{subband}} is the configured, pre-configured, or pre-defined SCS for the UL subband, and SCS_{UL}_{_{BWP}} is the SCS of the UL BWP.

Based on the methods in the above embodiments, a set of physical resources in the UL subband may be determined. The resource allocation for a UL transmission in the UL subband may be based on the set of physical resources. The following embodiments provide methods for resource allocation for a UL transmission in the UL subband.

In some embodiments of the present application, the BS may transmit DCI including an indication indicating a third set of resources in the UL BWP for the UL transmission in the UL subband. In such embodiments, the size of a frequency domain resource allocation field in the DCI may be the same as the size of a frequency domain resource allocation field in another DCI for scheduling a UL transmission in the UL BWP. Accordingly, no operation is needed for a BS to align the sizes of the two DCIs from a resource indication point of view.

In such embodiments, the BS may determine the second set of physical resources in the UL subband based on the third set of resources. For example, the BS may perform a resource mapping such that based on the third set of resources in the UL BWP, the BS may determine the corresponding second set of resources in the UL subband for UL transmission.

In some cases, the third set of resources and the second set of physical resources may have the same absolute positions in a frequency domain. For example, the third set of resources in the UL BWP may map to the second set of physical resources in the UL subband such that they are in the same absolute positions in the frequency domain.

In some cases, the third set of resources and the second set of physical resources have different absolute positions in the frequency domain. For example, the third set of resources in the UL BWP may map to the second set of physical resources in the UL subband such that they are in different absolute positions in the frequency domain.

In an embodiment, determining the second set of physical resources in the UL subband based on the third set of resources may further include determining the second set of physical resources in the UL subband based on the third set of resources and a mapping relationship between a set of resources (e.g., RB or RBGs) in the UL BWP and a set of resources (e.g., RB or RBGs) in the UL subband. The definitions regarding the mapping relationship in FIG. 5 may apply here.

In some embodiments, the mapping relationship may refer to that the set of resources (e.g., RB or RBGs) in the UL subband are one-to-one mapped to the set of resources (e.g., RB or RBGs) in the UL BWP or vice versa. For example, the mapping relationship may refer to that all the resources in the UL subband are one-to-one mapped to a set of resources in the UL BWP.

For example, in some cases, the mapping relationship may refer to that the set of resources (e.g., RB or RBGs) in the UL subband and the set of resources (e.g., RB or RBGs) in the UL BWP have the same positions in the frequency domain.

In some cases, the mapping relationship may be determined or defined by an offset (e.g., an RB offset or an RBG offset). In an embodiment, the offset may be configured or pre-configured for the UE or predefined. For example, assuming that the UL subband includes k RBs (e.g., denoted as RB #0-RB #k−1) and the offset is an RB offset “m,” then the mapping relationship may refer to that RB #0-RB #k−1 in the UL subband are mapped to RB #m-RB #m+k−1 in the UL BWP. In an embodiment, the offset may be determined based on the principle that the RBs or the RBGs of the UL subband have the same absolute frequency domain positions as the corresponding set of RBs or RBGs in the UL BWP. For example, it is assumed that the UL subband includes k RBs (e.g., denoted as RB #0-RB #k−1) and they are mapped to RB #m-RB #m+k−1 of the UL BWP, wherein RB #0-RB #k−1 of the UL subband have the same absolute frequency positions as RB #m-RB #m+k−1 of the UL BWP, and the RB offset is “m” in this example.

In some cases, resource allocation type 0 may be used for the resource allocation in the UL BWP. In such embodiments, the BS may transmit the DCI indicating a set of RBGs in the UL BWP for a UL transmission. The BS may determine a set of RBGs in the UL subband for the UL transmission based on the mapping relationship. Alternatively the BS may first determine a set of RBs in the UL BWP for the UL transmission from the set of RBGs in the UL BWP, and then determine a set of RBs in the UL subband for the UL transmission based on the set of RBs in the UL BWP and the mapping relationship.

In some cases, resource allocation type 1 may be used for the resource allocation in the UL BWP. In such embodiments, the BS may transmit the DCI including an RIV which indicates a set of RBs in the UL BWP for a UL transmission. The BS may determine a set of RBs in the UL subband for the UL transmission based on the set of RBs in the UL BWP and the mapping relationship.

In some embodiments of the present application, the BS may transmit DCI including an indication indicating the second set of physical resources in the UL subband for the UL transmission. In such embodiments, to align the sizes of the DCI and another DCI for scheduling a UL transmission in the UL BWP, the BS may add a padding bit(s) to one of a first frequency domain resource allocation field and a second frequency domain resource allocation field which has the smaller size, wherein the first frequency domain resource allocation field is included in the DCI and the second frequency domain resource allocation field is included in the another DCI for scheduling a UL transmission in the UL BWP, such that the sizes of the first frequency domain resource allocation field and the second frequency domain resource allocation field are the same.

In the above embodiments, the UL subband may be within the UL BWP in the frequency domain or may be not within the UL BWP in the frequency domain.

According to some embodiments of the present disclosure, the first set of physical resources may be configured in a UL BWP (e.g., the resource allocation for the UL subband may use solution 2 as stated above). In such embodiments, the first set of physical resources may be mapped to a set of physical resources in the DL BWP, such that the BS may determine the resources in the DL BWP for a PDSCH rate matching.

For example, the BS may scale the first set of physical resources based on the SCS of the UL BWP and the SCS of the DL BWP. The scaling may be performed based on the requirement that the SCS of the scaled first set of physical resources is the same as the SCS of the DL BWP.

For example, the BS may perform the scaling based on the following equation:

$${L}_{RB}^{′} = {L}_{RB} * \frac{{SCS}_{{UL}_{BWP}}}{{SCS}_{{DL}_{BWP}}} ,$$

wherein L′_{RB} is the number of RBs included in the scaled first set of physical resources, L_{RB} is the number of RBs included in the first set of physical resources allocated for the UL subband in the UL BWP, SCS_{DL}_{_{BWP}} is the SCS of the DL BWP, and SCS_{UL}_{_{BWP}} is the SCS of the UL BWP.

Then, the BS may map the scaled first set of physical resources to a third set of physical resources in the DL BWP. In some embodiments of the present application, the scaled first set of physical resources and the third set of physical resources in the DL BWP have the same absolute positions in a frequency domain.

In such embodiments, the UL subband includes the first set of physical resources. The resource allocation for a UL transmission in the UL subband may be based on the first set of physical resources. The following embodiments may provide methods for resource allocation for a UL transmission in the UL subband.

In some embodiments of the present application, the BS may transmit DCI including an indication indicating a fourth set of physical resources in the UL BWP for the UL transmission. In such embodiments, no operation is needed to align the sizes of the two DCIs from a resource indication point of view.

In such embodiments, the BS may determine the second set of physical resources in the UL subband based on the fourth set of physical resources. In an embodiment, determining the second set of physical resources in the UL subband for UL transmission may include mapping the fourth set of physical resources to the second set of physical resources in the UL subband, wherein the fourth set of physical resources and the second set of physical resources have the same absolute positions in a frequency domain.

For example, resource allocation type 0 may be used for the resource allocation in the UL BWP. In such example, the BS may transmit the DCI indicating a set of RBGs in the UL BWP for a UL transmission. The BS may determine a set of RBGs in the UL subband for the UL transmission, wherein the set of RBGs in the UL subband may have the same absolute positions in the frequency domain with the set of RBGs in the UL BWP.

In another example, resource allocation type 1 may be used for the resource allocation in the UL BWP. In such example, the BS may transmit the DCI including an RIV which indicates a set of RBs in the UL BWP for a UL transmission. The BS may determine a set of RBs in the UL subband for the UL transmission, wherein the set of RBs in the UL subband may have the same absolute positions in the frequency domain with the set of RBs in the UL BWP.

In some embodiments of the present application, the BS may transmit DCI including an indication indicating a set of physical resources in the UL subband for the UL transmission. In such embodiments, the second set of physical resources in the UL subband for a UL transmission in step 503 may be the set of physical resources indicated by the DCI.

In such embodiments, to align the sizes of the DCI and another DCI for scheduling a UL transmission in the UL BWP from a resource indication point of view, the BS may add a padding bit(s) to a frequency domain resource allocation field in the DCI such that a size of the frequency domain resource allocation field is the same as a size of a frequency domain resource allocation field in another DCI for scheduling a UL transmission in the UL BWP.

According to some embodiments of the present application, the size of the DCI for scheduling a UL transmission in a UL subband should be the same as the size of the DCI for scheduling a UL transmission in a UL BWP. If the two DCIs have different sizes, the BS may add a padding bit(s) to one of the DCI scheduling the UL transmission in the UL subband and the DCI scheduling the UL transmission in the UL BWP which has the smaller size, such that the sizes of the two DCIs may be aligned (e.g., equal to each other).

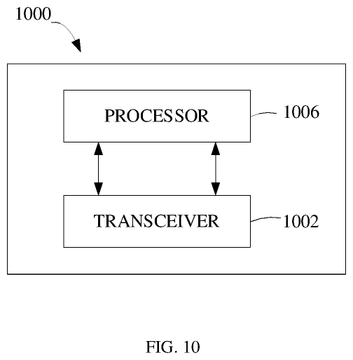

FIG. 10 illustrates a simplified block diagram of an exemplary apparatus for a UL subband in a full duplex system according to some embodiments of the present disclosure. As shown in FIG. 10, the apparatus 1000 may include at least one processor 1006 and at least one transceiver 1002 coupled to the processor 1006. The apparatus 1000 may be a UE or a BS.

Although in this figure, elements such as the at least one transceiver 1002 and processor 1006 are described in the singular, the plural is contemplated unless a limitation to the singular is explicitly stated. In some embodiments of the present disclosure, the transceiver 1002 may be divided into two devices, such as a receiving circuitry and a transmitting circuitry. In some embodiments of the present disclosure, the apparatus 1000 may further include an input device, a memory, and/or other components.

In some embodiments of the present disclosure, the apparatus 1000 may be a UE. The transceiver 1002 and the processor 1006 may interact with each other so as to perform the operations with respect to the UE described in FIGS. 1-9. In some embodiments of the present disclosure, the apparatus 1000 may be a BS. The transceiver 1002 and the processor 1006 may interact with each other so as to perform the operations with respect to the BS described in FIGS. 1-9.

In some embodiments of the present disclosure, the apparatus 1000 may further include at least one non-transitory computer-readable medium.

For example, in some embodiments of the present disclosure, the non-transitory computer-readable medium may have stored thereon computer-executable instructions to cause the processor 1006 to implement the method with respect to the UE as described above. For example, the computer-executable instructions, when executed, cause the processor 1006 interacting with transceiver 1002 to perform the operations with respect to the UE described in FIGS. 1-9.

In some embodiments of the present disclosure, the non-transitory computer-readable medium may have stored thereon computer-executable instructions to cause the processor 1006 to implement the method with respect to the BS as described above. For example, the computer-executable instructions, when executed, cause the processor 1006 interacting with transceiver 1002 to perform the operations with respect to the BS described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

Please make the following amendments to the claims:

1. A user equipment (UE), comprising:
at least one memory; and
at least one processor coupled with the at least one memory and configured to cause the UE to:
receive configuration information which configures a first set of physical resources for an uplink (UL) subband; and
determine a second set of physical resources in the UL subband for a UL transmission based on the configuration information.

2. The UE of claim 1, wherein the first set of physical resources is configured in a downlink (DL) bandwidth part (BWP).

3. The UE of claim 2, wherein the at least one processor is configured to cause the UE to scale the first set of physical resources based on a subcarrier spacing (SCS) of the DL BWP and an SCS of a UL BWP.

4. The UE of claim 1, wherein the first set of physical resources is configured in a network carrier and a subcarrier spacing (SCS) for the UL subband is configured or pre-configured for the UE or predefined.

5. The UE of claim 4, wherein the at least one processor is configured to cause the UE to scale the first set of physical resources based on the SCS for the UL subband and an SCS of a UL BWP.

6. The UE of claim 5, wherein the at least one processor is configured to cause the UE to receive downlink control information (DCI) including an indication indicating a third set of resources in the UL BWP for the UL transmission, and wherein determining the second set of physical resources in the UL subband for UL transmission includes:
determining the second set of physical resources in the UL subband based on the third set of resources.

7. The UE of claim 6, wherein determining the second set of physical resources in the UL subband based on the third set of resources further comprises determining the second set of physical resources in the UL subband based on the third set of resources and a mapping relationship between a set of resources in the UL BWP and a set of resources in the UL subband.

8. The UE of claim 7, wherein the mapping relationship is determined based on an offset, and wherein the offset is configured or pre-configured for the UE or predefined.

9. The UE of claim 5, wherein the at least one processor is configured to cause the UE to receive downlink control information (DCI) indicating the second set of physical resources in the UL subband for the UL transmission.

10. The UE of claim 9, wherein a padding bit(s) is added to one of a first frequency domain resource allocation field and a second frequency domain resource allocation field which has the smaller size, wherein the first frequency domain resource allocation field is included in the DCI and the second frequency domain resource allocation field is included in another DCI for scheduling a UL transmission in the UL BWP.

11. The UE of claim 1, wherein the first set of physical resources is configured in a UL bandwidth part (BWP).

12. The UE of claim 11, wherein the at least one processor is configured to cause the UE to:
scale the first set of physical resources based on a subcarrier spacing (SCS) of the UL BWP and an SCS of a downlink (DL) BWP; and
map the scaled first set of physical resources to a third set of physical resources in the DL BWP.

13. The UE of claim 11, wherein the at least one processor is configured to cause the UE to receive downlink control information (DCI) indicating a fourth set of physical resources in the UL BWP for the UL transmission, and wherein determining the second set of physical resources in the UL subband for UL transmission includes:
mapping the fourth set of physical resources to the second set of physical resources in the UL subband, wherein the fourth set of physical resources and the second set of physical resources have the same absolute positions in a frequency domain.

14. A base station, comprising:
at least one memory; and
at least one processor coupled with the at least one memory and configured to cause the base station to:
transmit configuration information which configures a first set of physical resources for an uplink (UL) subband; and
determine a second set of physical resources in the UL subband for a UL transmission based on the configuration information.

15. A method performed by a user equipment (UE), the method comprising:
receiving configuration information which configures a first set of physical resources for an uplink (UL) subband; and
determining a second set of physical resources in the UL subband for a UL transmission based on the configuration information.

16. A processor for wireless communication, comprising:
at least one controller coupled with at least one memory and configured to cause the processor to:
receive configuration information which configures a first set of physical resources for an uplink (UL) subband; and
determine a second set of physical resources in the UL subband for a UL transmission based on the configuration information.

17. The processor of claim 16, wherein the first set of physical resources is configured in a downlink (DL) bandwidth part (BWP).

18. The processor of claim 17, wherein the at least one controller is configured to cause the processor to scale the first set of physical resources based on a subcarrier spacing (SCS) of the DL BWP and an SCS of a UL BWP.

19. The processor of claim 16, wherein the first set of physical resources is configured in a network carrier and a subcarrier spacing (SCS) for the UL subband is configured or pre-configured for the processor or predefined.

20. The processor of claim 19, wherein the at least one controller is configured to cause the processor to scale the first set of physical resources based on the SCS for the UL subband and an SCS of a UL BWP.
